(19) United States
(12) Patent Application Publication
(10) Pub. No.: US 2009/0037945 A1
(43) Pub. Date: Feb. 5, 2009

(54) MULTIMEDIA PRESENTATION APPARATUS, METHOD OF SELECTING MULTIMEDIA CONTENT, AND COMPUTER PROGRAM PRODUCT

(75) Inventors: Darryl Greig, Bristol (GB); Yuxin Liu, Sunnyvale, CA (US); Nelson Liang An Chang, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 11/831,355

(22) Filed: Jul. 31, 2007

(51) Int. Cl. H04N 7/00

(52) U.S. Cl. 725/10

(57) ABSTRACT

Provided is a multimedia presentation apparatus comprising:
a playback module operable to playback multimedia content;
a sensor module operable to measure a characteristic of the behavior of at least one individual in an audience indicative of attention paid by the at least one individual to the multimedia content;
a processing module for determining a state of the audience based on the characteristic of the at least one individual, and for selecting multimedia content for playback based on the state of the audience.

### FIELD OF THE INVENTION

The invention relates to the field of multimedia presentation.

### BACKGROUND

Multimedia content is provided to audiences at a variety of locations. In public spaces such as shopping malls, and airports, there is a large potential audience for providers of multimedia content such as advertisers. In such public spaces, the content is usually provided according to a fixed structure based on idealized projections of audience behavior.

US2007/0061838 discloses a media presentation system including a base unit with motion sensors that can determine if there is movement in front of the base unit. Movement indicates the presence of viewers. The base unit may be able to count the number of people in front the display at any given point in time. Triggers can be implemented by advertisers to display messages once the count exceeds or is less than a threshold designated by the advertiser.

### SUMMARY OF THE INVENTION

According to an embodiment of the invention there is provided a multimedia presentation apparatus. The multimedia presentation apparatus comprises a playback module operable to playback multimedia content. The multimedia presentation apparatus further comprises a sensor module operable to measure a characteristic of the behavior of at least one individual in an audience indicative of attention paid by the at least one individual to the multimedia content. The multimedia presentation apparatus further comprises a processing module for determining a state of the audience based on the characteristic of the at least one individual, and for selecting multimedia content for playback based on the state of the audience.

### BRIEF DESCRIPTION OF THE DRAWINGS

In the following, embodiments of the invention will be described, by way of example only, and with reference to the drawings in which:

FIG. 1 is a block diagram of a multimedia presentation apparatus,

FIG. 2 is a flow diagram illustrating steps involved in selecting multimedia content for playback,

FIG. 3 is a block diagram of a multimedia playback apparatus,

FIG. 4 illustrates the use of trajectories of audience members in the determination of a state of the audience,

FIG. 5 is a flow diagram showing steps involved in a method of selecting multimedia content based on the trajectories of audience members.

### DETAILED DESCRIPTION

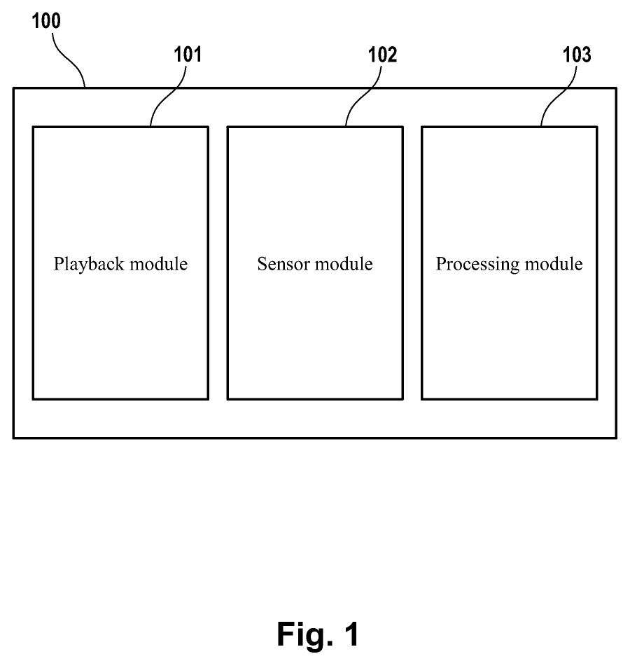

FIG. 1 illustrates a block diagram of a multimedia presentation apparatus 100. The multimedia presentation apparatus comprises a playback module 101 for playback of multimedia content. This may include visual presentation of multimedia content through a screen such as a cathode ray tube, an LCD screen, a plasma screen or a projection screen. It may also include audio playback of multimedia content including spoken word, music, or sound effects. The multimedia presentation apparatus 100 also comprises a sensor module 102 for measuring a characteristic of the behavior of members of the audience. The sensor module may include a TV camera, or a motion sensor such as a passive infrared detector or an active ultrasonic or microwave detector. The multimedia presentation apparatus 100 also includes a processing module 103. The processing module determines a state of the audience based on the output of the sensor module 102. Based on the state of the audience determined by the processing module, the processing module selects multimedia content for playback by the playback module 101. The modules may be realized as a single integrated device, or may be implemented at separate locations. The modules may be realized as software, hardware, or a combination of the two. The sensor module 102 is directed to detect people in front of the display from the playback module 101.

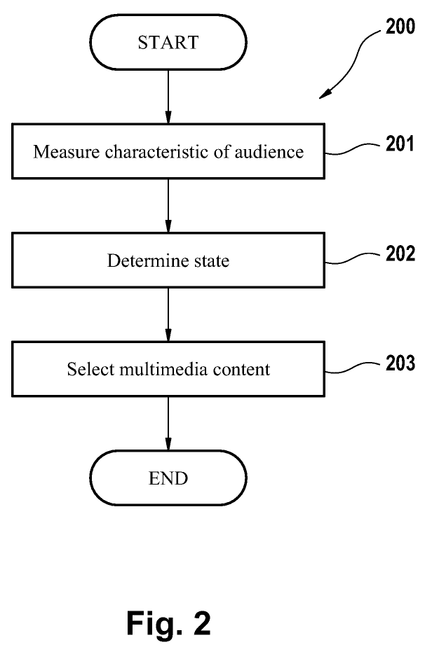

FIG. 2 shows a method 200 for selecting multimedia content for playback by the playback module 101. In step 201 a characteristic of the audience is measured. The characteristic of the audience measured in step 201 is indicative of the attention paid by the audience to the multimedia content played by the playback module 101. The characteristic of the audience may be the motion of the audience, for example of the direction of motion of the audience may determine the attention paid by the audience to the playback module. The characteristic of the audience may also be determined from recognition of the face of members of the audience. When determining the characteristic of the audience in step 201 the amount of time that members of the audience have been in the vicinity of the playback module may also be determined. In step 202 the state of the audience is determined from the characteristic of the audience measured in step 201. The state of the audience may be that there is no audience present, that the audience consists mostly of new arrivals, that the audience consists mostly of people who have viewed certain items of content, it may also include reaction of the audience to items of content recently displayed on the playback module, it may also include demographic information about the audience. Once the state of the audience is determined in step 202, multimedia content is selected in step 203 based on the state of the audience.

The multimedia content may be stored in a repository and selected based on the state of the audience. Content may be grouped into an attract mode, a retain mode, and an inform mode. With the attract mode being designed to attract the attention of passers by to a playback module. Thus, when the sensor module detected that few audience members were present or that few audience members were paying attention to the playback module, multimedia could be played back in the attract mode. Transition may then be made to a retain mode once a certain number of audience members are detected paying attention to the playback module. Once it has been determined that a certain number of viewers have viewed the playback module in the retain mode a further transition to an inform mode could be made. The multimedia presentation apparatus 100 therefore allows dynamically responsive content to be displayed. Providers of multimedia content are therefore to control and adjust the playback of content based on the attention of the audience to the content.

When there are no audience members present, the processing module 103 may be operable to select a sleep mode in which the playback module is transitioned to a power off mode or a power saving mode.

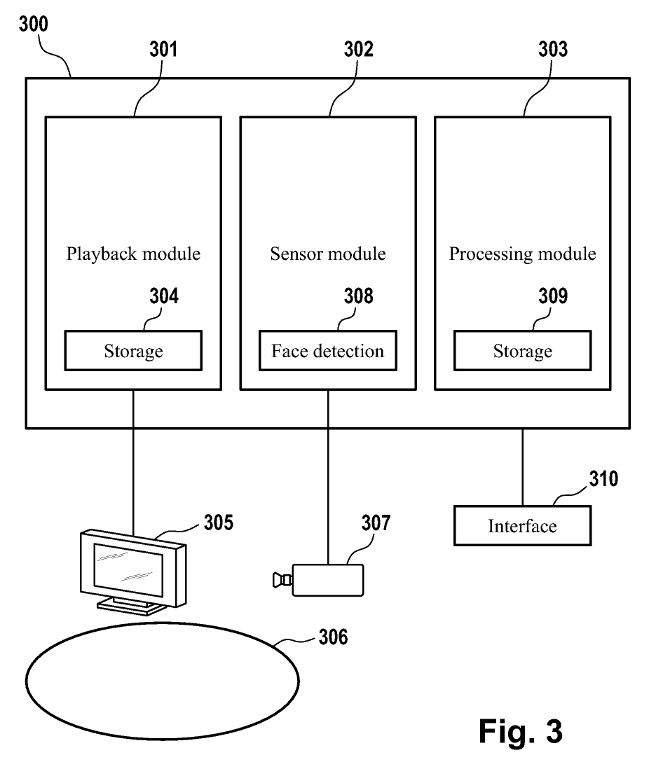

FIG. 3 shows a multimedia presentation apparatus 300 for playback of multimedia content based on viewer face monitoring. The playback module 301 includes storage 304 for content to be played back on screen 305. The storage may be removable or fixed. Removable storage may be optical such as DVD or magnetic such as a video tape. Fixed storage includes hard disk drives and solid state storage. Multimedia content stored in storage 304 may be tagged as to which states or transitions between states of the audience that is most suitable. There may be particular pieces of content for a particular state of the audience or there may be a number of items of content each having tags describing states or transitions between states in the audience to which the content is most suitable. Screen 305 displays content to an audience in perception area 306. Camera 307 is positioned to capture the faces of audience members in area 306. Sensor module 302 includes a face detection functionality 308 which detects faces in the output from camera 307. The face detection functionality 308 may be able to determine the direction faced by audience members in the perception area 306. Individuals in the audience may be recognized by their faces and the length of time that the individual has viewed screen 305 may be determined. Face detection functionality 308 may be operable to determine the expression of audience members and therefore to determine their reactions to the multimedia content displayed on screen 305. Face detection functionality 308 may also be able to determine demographic data from faces of members of the audience such as the age bracket in which they fall and the sex of the members of the audience. The state of the audience may then be the demographic of the majority of the audience. The processing module 303 includes storage 309. Storage 309 may store information relating to the content shown and the number of viewers. This would allow advertisers to be charged based on the number of viewers of their advertising content. The storage 309 may also store audience reactions to the content displayed by screen 305, for example by storing the state of the audience, and the numbers of audience members paying attention to the multimedia content and the number leaving and not paying attention to the content. Alternatively the facial expressions of the audience may also be used to determine the state of the audience as a reaction to the content. This would allow content providers to gain feedback on the content displayed on screen 305. Multimedia playback apparatus 300 is connected to interface 310 this may be for example a network connection and would allow the uploading of data such as statistics for billing of advertisers and for feedback of audience reactions to multimedia content. Additionally, new multimedia content could be downloaded through interface 310.

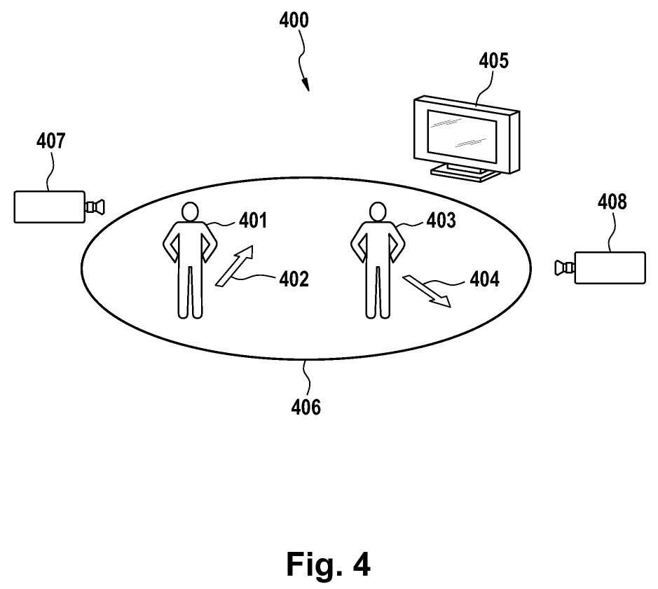

FIG. 4 illustrates the use of trajectories for audience members in the presentation of multimedia content. Audience member 401 has trajectory of motion 402, and audience member 403 has trajectory of motion 404. Both are in the vicinity of screen 405 which has perception space 406. Detectors 407 and 408 are able to detect the motion of audience members in the perception space 406. The attention of audience members 401 and 403 to the multimedia content displayed on screen 405 may be determined from their directions of motion shown by trajectories 402 and 404. The state of the audience may be determined from the direction of motion of members of the audience, the distance between members of the audience and the display 405, the number of trajectories towards the display, or the directions faced by members of the audience. It may be advantageous to include the direction faced by members of the audience in addition to their trajectory when determining the attention paid by the audience to the screen 405. For example audience member 403 has trajectory 404 away from screen 405, but it may be determined that they are in fact facing the screen 405 and thus could potentially have their behavior modified by gaining their attention by playing targeted multimedia content.

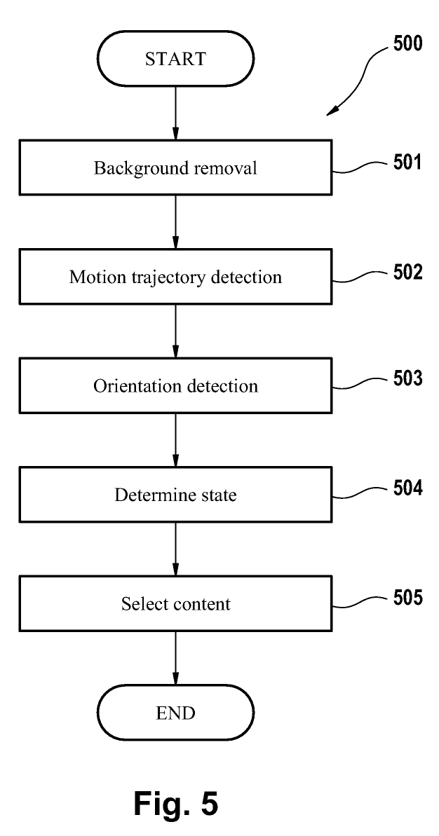

FIG. 5 shows a method 500 for using the motion trajectory of audience members to control the playback of multimedia content. In step 501 the background is removed. This may be achieved by for example subtracting non-moving parts from a video recording of the audience. Alternatively audience members may be detected using skin recognition and the detection and removal of shadows. Once audience members have been detected their motion trajectories are detected in step 502. This may for example be by using a technique of image difference. In step 503, the orientation of audience members is detected. In step 504 the state of the audience is determined from the motion trajectories detected in step 502 and the orientation of members of the audience detected in step 503. In step 505, content is selected for playback based on the state determined in step 504.

The state of the audience used to determine the multimedia content may include factors such as the time of day, the day of the week, the time of the year, and any upcoming events or holidays. The multimedia content may be selected using an algorithm taking into account factors such as information about a rate at which an advertiser has purchased advertising, a running count of the number of impressions made by a particular piece of content and observed audience reactions to a piece of content.

List of Reference Numerals

| | |
|---|---|
| 100 | Multimedia presentation apparatus |
| 101 | Playback module |
| 102 | Sensor module |
| 103 | Processing module |
| 200 | Method |
| 201 | Measure characteristic of audience |
| 202 | Determine state |
| 203 | Select multimedia content |
| 300 | Multimedia presentation apparatus |
| 301 | Playback module |
| 302 | Sensor module |
| 303 | Processing module |
| 304 | Storage |
| 305 | Screen |
| 306 | Perception area |
| 307 | Camera |
| 308 | Face detection |
| 309 | Storage |
| 310 | Interface |
| 400 | Use of trajectories |
| 401 | Audience member |
| 402 | Trajectory |
| 403 | Audience member |
| 404 | Trajectory |
| 405 | Screen |
| 406 | Perception space |
| 407 | Detector |
| 408 | Detector |
| 500 | Method |
| 501 | Background removal |
| 502 | Motion trajectory detection |
| 503 | Orientation detection |
| 504 | Determine state |
| 505 | Select content |

1. A multimedia presentation apparatus comprising:
a playback module operable to playback multimedia content;
a sensor module operable to measure a characteristic of the behavior of at least one individual in an audience indicative of attention paid by the at least one individual to the multimedia content;
a processing module for determining a state of the audience based on the characteristic of the at least one individual, and for selecting multimedia content for playback based on the state of the audience.

2. The multimedia presentation apparatus of claim 1, the processing module further operable to determine the state of the at least one individual based on the characteristic and an amount of time that the individual has exhibited the characteristic.

3. The multimedia apparatus of claim 2, the processing module further operable to determine the items of multimedia content viewed by the at least one individual from the amount of time and the multimedia content played back

4. The multimedia presentation apparatus of claim 1, the sensor module further operable to determine the presence of the at least one individual and the processing module further operable to select a sleep mode for the playback module if no individual is present.

5. The multimedia presentation apparatus of claim 1, further comprising a storage module operable to store data identifying the multimedia content played by the playback module and the corresponding state of the audience.

6. The multimedia presentation apparatus of claim 1, the sensor module being operable to detect the face of the at least one individual and the characteristic being a characteristic of the face of the individual.

7. The multimedia presentation apparatus of claim 6, the sensor module being further operable to determine at least one item of demographic data from the face of the at least one individual, the processing module further adapted to determine the state of the audience based on the at least one item of demographic data.

8. The multimedia presentation apparatus of claim 6, the characteristic of the face of the at least one individual being a facial expression of the at least one individual.

9. The multimedia presentation apparatus of claim 1, the sensor module being operable to detect the direction of motion of the at least one individual and the characteristic being the trajectory of the at least one individual.

10. The multimedia presentation apparatus of claim 9, the sensor module further operable to determine the orientation of the individual, and the characteristic being the trajectory and the orientation of the at least one individual.

11. A method of selecting multimedia content for playback comprising;
measuring a characteristic of the behavior of at least one audience member;
determining a state from a plurality of states of the audience based on the characteristic of the behavior of the at least one audience member;
selecting multimedia content based on the determined state of the audience.

12. The method of claim 11, the step of measuring further comprising recording the time at which the characteristic was measured, the step of determining a state further comprising determining which multimedia content has been played back in the presence of the at least one audience member.

13. The method of claim 11, the plurality of states including a state in which no audience is present, the method further comprising the step of selecting a sleep mode if no audience is present.

14. The method of claim 11, further comprising the step of storing data indicative of the state of the audience and the multimedia content played back.

15. The method of claim 11, the characteristic being a characteristic of the face of the at least one audience member.

16. The method of claim 15, the characteristic of the face of the at least one audience member being an item of demographic data.

17. The method of claim 11, the characteristic being a characteristic of the motion of the at least one audience member.

18. A computer program product comprising instructions which when executed perform a method for selecting multimedia content comprising:
receiving a measurement of a characteristic of the behavior of at least one audience member;
determining a state from a plurality of states of the audience based on the characteristic of the behavior of the at least one audience member;
selecting multimedia content based on the determined state of the audience.

19. The computer program product of claim 18, the characteristic being a characteristic of the face of the at least one audience member.

20. The computer program product of claim 18, the characteristic being a characteristic of the motion of the at least one audience member.
